(19) United States
(12) Patent Application Publication
(10) Pub. No.: US 2026/0326719 A1
(43) Pub. Date: Oct. 22, 2026

(54) SYSTEM FOR PROJECTING A CLEANING LIQUID, HAVING VALVE PURGING MEANS

(71) Applicant: VALEO SYSTEMES D'ESSUYAGE, La Verriere (FR)

(72) Inventors: Nicolas HORNYCH, La Verriere (FR); Denis THEBAULT, La Verriere (FR)

(73) Assignee: VALEO SYSTEMES D'ESSUYAGE, La Verriere (FR)

(21) Appl. No.: 19/113,056

(22) PCT Filed: Aug. 24, 2023
(86) PCT No.: PCT/EP2023/073301

§ 371 Date: Mar. 19, 2025

(30) Foreign Application Priority Data
Sep. 21, 2022 (FR) 2209530

(51) Int. Cl. B60S 1/48; F16K 15/14; F16K 31/06

(52) U.S. Cl. CPC B60S 1/481; F16K 15/148; F16K 31/0658

(57) ABSTRACT

The invention relates to a system for spraying a cleaning liquid. The system including a means for purging the valve body, with the purging means being configured to allow air to enter the system.

### TECHNICAL FIELD

The invention relates to the field of systems for spraying cleaning liquid for motor vehicles, and in particular to the valves used in these systems.

### BACKGROUND OF THE INVENTION

Motor vehicles, all of which are provided with a system for spraying cleaning liquid in order to keep the windshield of the vehicle clean and to allow the driver to see out optimally, are already known from the prior art. Other optical devices, such as sensors, may also require such spraying systems.

These systems generally comprise a cleaning liquid reservoir, a pump and at least one valve configured to allow or prevent the passage of the cleaning liquid to the various spray endpieces (also referred to as “nozzles”).

One of the problems with the hydraulic valves placed in the hydraulic circuit of the spraying systems is the risk of said valves malfunctioning, which is associated with them becoming frosted. Moreover, in the event of very low temperatures, the cleaning liquid present in the valve may freeze, thereby resulting in damage to the valve due to the water expanding as it freezes, causing the system for spraying cleaning liquid to fail.

In order to avoid such damage to the valves in the event of freezing or frosting, it is known practice to attempt to purge the valve after the system has been used. Nevertheless, systems for spraying cleaning liquid generally comprise one or more nonreturn valves, arranged either between the hydraulic valve and the spray endpiece, or directly within the spray endpiece. Such a nonreturn valve ensures that no fluid may enter the system, in particular rain or water from a car wash. The valve also makes it possible to prevent the cleaning liquid from leaking outside of the cleaning phases; without a nonreturn valve, once the pump is turned off, it would be possible for a few drops to escape from the nozzle and obstruct a sensor associated with the nozzle. However, the presence of this nonreturn valve makes operations of purging the valves difficult since they require air (or gas) to enter the system, in a direction of fluidic movement counter to the direction in which the cleaning liquid is injected through the valve towards the spray endpiece, specifically in order to be able to remove the cleaning liquid from the body of the valve without the risk of the valve being damaged.

It is therefore necessary to find a solution for systems for spraying cleaning liquid for motor vehicles that allows operations of purging the valves that are both effective and repeatable over time and that protect these valves against damage caused by the purging operations.

The invention aims in particular to overcome the abovementioned drawbacks by proposing a system that makes it possible to ensure operations of purging the valves that are effective and repeatable over time, making it possible to protect them from the risks of damage associated with very low temperatures of the cleaning liquid, and that does not entail significant modifications compared to the known systems. Such a solution is therefore particularly advantageous because it makes it possible to solve the abovementioned problems while at the same time being able to be implemented rapidly without any major modification to the existing systems.

### SUMMARY OF THE INVENTION

To this end, the invention relates to a system for spraying a cleaning liquid, comprising:
a cleaning liquid reservoir,
a pump,
at least one spray endpiece for spraying cleaning liquid,
a nonreturn valve configured to prevent any fluid from entering the system from the spray endpiece for spraying liquid and
at least one valve comprising a valve body intended to receive the cleaning liquid and to selectively conduct it between the pump (24) and the at least one spray endpiece.

According to the invention, the system for spraying a cleaning liquid comprises means for purging the valve body, the purging means being configured to allow gas to enter the system.

According to further optional features of the system, taken individually or in combination:
the valve is a first valve, the purging means comprising a second valve comprising an orifice fluidically connected to an orifice of the first valve and a second orifice allowing the gas to enter the second valve;
the second orifice of the second valve is fluidically connected to the outside ambient air;
the first valve and the second valve are arranged so as to allow the cleaning liquid to return to the pump and to the liquid reservoir under the effect of gravity;
the pump comprises a reversible motor, the pump being configured to supply cleaning liquid to the valve body, in a first direction of rotation of the motor, and to draw the cleaning liquid from the valve body, in a second direction of rotation of the motor;
the valve is a valve comprising three orifices, the system comprising a second nonreturn valve arranged on one of the orifices, said second nonreturn valve being configured to prevent the passage of fluid when the motor of the pump is operating in the first direction of rotation and to allow air to pass when the motor of the pump is operating in the second direction of rotation;
the second nonreturn valve comprises a deformable diaphragm, the diaphragm being configured to deform under the action of a negative pressure generated by the pump when the motor of the pump is operating in the second direction of rotation;
the second nonreturn valve comprises a deformable cylinder, the cylinder being configured to deform under the action of a negative pressure generated by the pump when the motor of the pump is operating in the second direction of rotation;
the valve is an electromagnetic valve also comprising a coil configured to cause the plunger to move from the closed position to the open position and vice versa ..

### BRIEF DESCRIPTION OF DRAWINGS

The invention will be better understood upon reading the following description, which is provided solely by way of example and with reference to the appended drawings, in which:

FIG. 1 is a view depicting a system for spraying a cleaning liquid according to the invention,

FIG. 2 is a view depicting the valve of the system from FIG. 1,

FIG. 3 is a view depicting purging means according to a first embodiment of the invention,

FIG. 4A and FIG. 4B are a set of views illustrating part of the purging means according to a second embodiment of the invention, and

FIG. 5A and FIG. 5B are a set of views illustrating part of the purging means according to a variant of the second embodiment of the invention.

In these figures, elements that are identical bear the same reference signs.

### DETAILED DESCRIPTION OF THE INVENTION

The embodiments that follow are examples. Although the description refers to one or more embodiments, this does not necessarily mean that each reference relates to the same embodiment, or that the features apply only to one embodiment. Individual features of different embodiments may also be combined or interchanged in order to provide other embodiments.

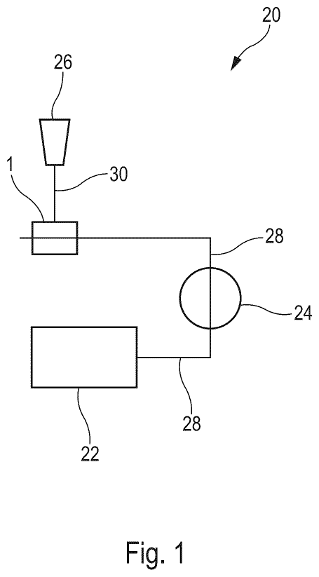

FIG. 1 depicts a system 20 for spraying cleaning liquid, comprising a liquid reservoir 22, a pump 24, a spray endpiece 26 for spraying the cleaning liquid, which are configured for example to spray a cleaning liquid over the windshield or over optical elements of a motor vehicle. The spraying system 20 also comprises a valve 1 for controlling the distribution of the cleaning liquid to the spray endpiece 26. The valve 1 is connected to the reservoir 22 by a supply hose 28 and the spray endpiece 26 is connected to the valve 1 by a distribution hose 30. A nonreturn valve (not depicted) is present in the spray endpiece 26 or is situated between the latter and the valve 1. The spraying system 20 according to the invention also comprises means (not depicted in FIG. 1) for purging the valve body 3, the purging means being configured to allow air to enter the system 20.

In addition, the spraying system 20 may also comprise a plurality of valves supplying a plurality of spray endpieces, thus making it possible to supply cleaning liquid to a plurality of destinations in the vehicle in which the system 20 is implemented.

The valve 1 is for example an electromagnetic valve comprising a coil 13 that, when it is supplied with power, makes it possible to control the movement of a plunger 7 as described in the remainder of the description. However, the invention is not limited to electromagnetic valves and may also be applied to other valve types.

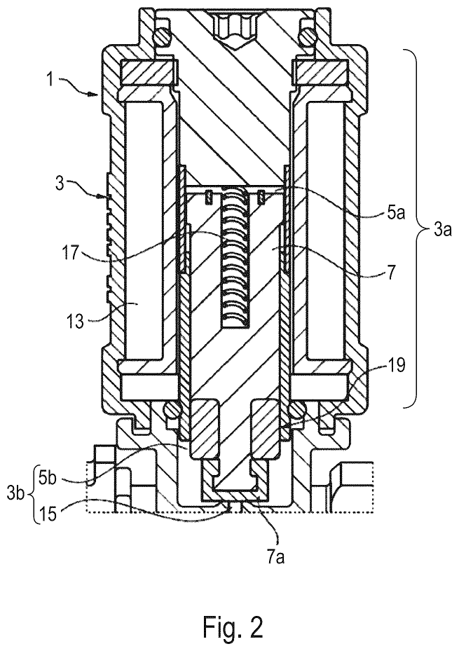

FIG. 2 depicts a sectional view of the electromagnetic valve 1 showing the internal elements of the electromagnetic valve 1. The electromagnetic valve 1 comprises a valve body 3 enclosing a hydraulic cavity 5 in which a plunger 7 is positioned. The valve body 3 comprises a first part 3a comprising a coil 13 arranged around a first portion 5a of the hydraulic cavity 5 and a second part 3b in which are formed a first orifice 9, corresponding to an inlet orifice for the fluid, and a second orifice 11, corresponding to an outlet orifice for the fluid, and enclosing a second portion 5b of the hydraulic cavity 5.

The first orifice 9 is configured to be attached to a supply hose 28 for the fluid, for example a cleaning or washing liquid. The supply hose 28 is for example connected to a cleaning liquid reservoir 22 via a supply pump 24 for supplying the cleaning liquid, as in FIG. 1.

The second orifice 11 is configured to be attached to a spray endpiece 26 via a distribution hose 30.

The electromagnetic valve 1 also comprises a hydraulic channel 15 connecting the first orifice 9 and the second orifice 11, said hydraulic channel 15 being in fluidic communication with the hydraulic cavity 5 in which the plunger 7 is arranged (the hydraulic channel 15 therefore locally coincides with the second portion 5b of the hydraulic cavity 5). The hydraulic channel 15 is configured to be continued on either side of the electromagnetic valve 1, in particular via the hoses 28, 30, so as to transfer the cleaning liquid from the reservoir 22 to a spray endpiece 26.

The plunger 7 is configured to be moved between an open position (not depicted), in which it allows the cleaning liquid to pass between the supply hose 28 and the distribution hose 30, and a closed position (depicted in FIG. 2), in which it prevents the passage of the cleaning liquid between the supply hose 28 and the distribution hose 30.

The plunger 7 comprises a first portion 7a, corresponding to a flexible end in the present case, for example an elastomer or rubber end, so as to allow good leaktightness in the closed position, the first portion 7a coming into contact with a wall of the valve body 3 in the closed position in order to prevent the passage of the cleaning liquid through the hydraulic channel 15, that is to say between the first orifice 9 and the second orifice 11. The plunger 7 is moved from the closed position to the open position by supplying the coil 13 with power (for example above a predetermined voltage threshold). An elastic stressing element 17, for example a helical spring, may be arranged between the valve body 3 (or an element that is fixed with respect to the valve body 3) and the plunger 7 and configured to place the plunger 7 under stress in the closed position when power is not supplied to the coil 13 (or if the power supplied is lower than the predetermined voltage threshold).

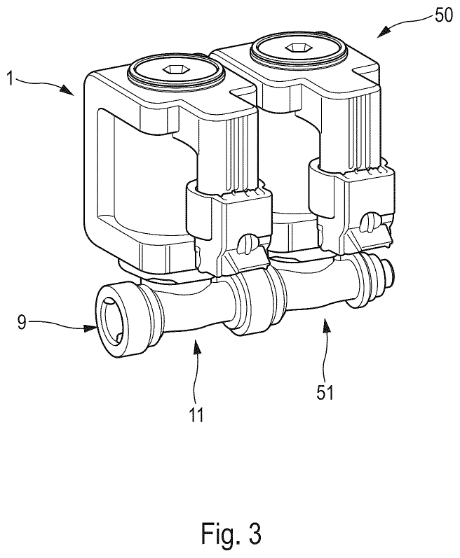

According to a first embodiment of the invention (FIG. 3), the purging means comprise a second valve 50 itself comprising a first orifice fluidically connected to an orifice of the first valve 1 and a second orifice 51 allowing the gas to enter the second valve 50. Advantageously, this second valve 50 is also an electromagnetic valve, the piston of which may be remotely controlled so as to allow gas to enter the system 20 when the operation of purging the first valve 1 is required. More precisely, the second orifice 51 of the second valve 50 is connected to the outside ambient air, this having the advantage of allowing air to enter the liquid spraying system 20 in a manner that is simple to implement. In order to allow the first valve 1 to be purged in a manner that is even simpler to implement, so that the current systems do not need to be significantly modified, the first valve 1 and the second valve 50 are arranged so as to allow the cleaning liquid to return to the pump 24 and to the liquid reservoir 22 under the effect of gravity. In other words, the assembly formed by the first valve 1 and the second valve 50 is elevated, within the vehicle in which the system 20 is installed, with respect to the pump 24 and the reservoir 22, thereby allowing the cleaning liquid stored in the valve body 3 of the first valve 1 to be moved under the effect of gravity and replaced by the air entering the system 20, via the second valve 50.

According to a second embodiment of the system of the invention, the pump 24 comprises a reversible motor (not depicted) and is configured to supply cleaning liquid to the valve body 3, in a first direction of rotation of the motor, and to draw the cleaning liquid from the valve body 3, in a second direction of rotation of the motor. Thus, it is possible to cause the cleaning liquid to be moved in a direction counter to the injection direction when the operation of purging the body of the valve 3 is necessary, without significant modification to the system 20. The pump 24 is therefore a pump that is generally referred to as a reversible pump and forms part of the purging means of this second embodiment. The purging means further comprise an element allowing air to enter the system 20, so that operating the motor in the second direction of rotation (the direction of rotation allowing the purging operation) does not create too great a negative pressure within the system 20, which would risk damaging the various components thereof. According to a first variant of this embodiment, this element allowing air to enter is a second valve 50, similar to the one described in the context of the first embodiment (FIG. 3), in fluidic communication, on the one hand, with the first valve 1 and, on the other hand, with the outside ambient air. This configuration has the advantage, unlike the above-described first embodiment, of not requiring an arrangement of the first valve 1—second valve 50 assembly that allows the cleaning liquid to return to the pump and to the liquid reservoir under the effect of gravity, since this return is brought about by the pump 24 itself. Thus, the liquid spraying system 20 according to this embodiment is more compact and therefore easier to implement within the vehicle.

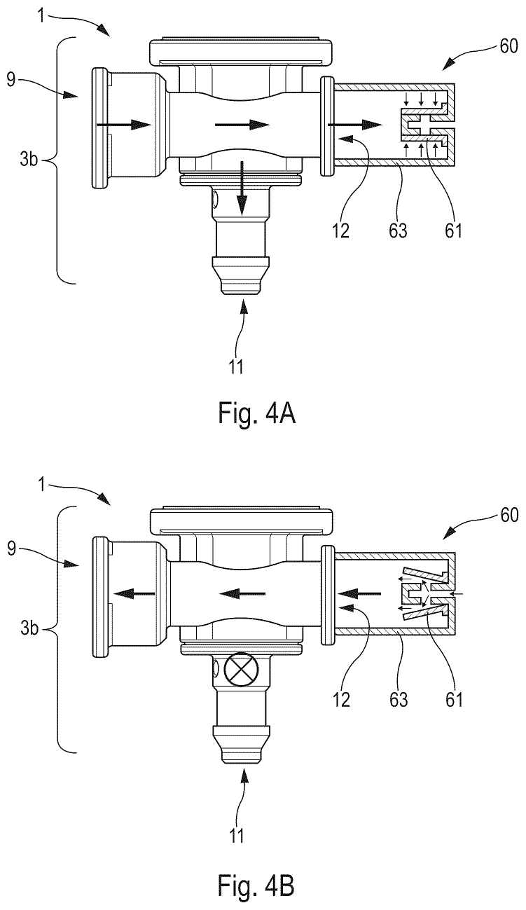

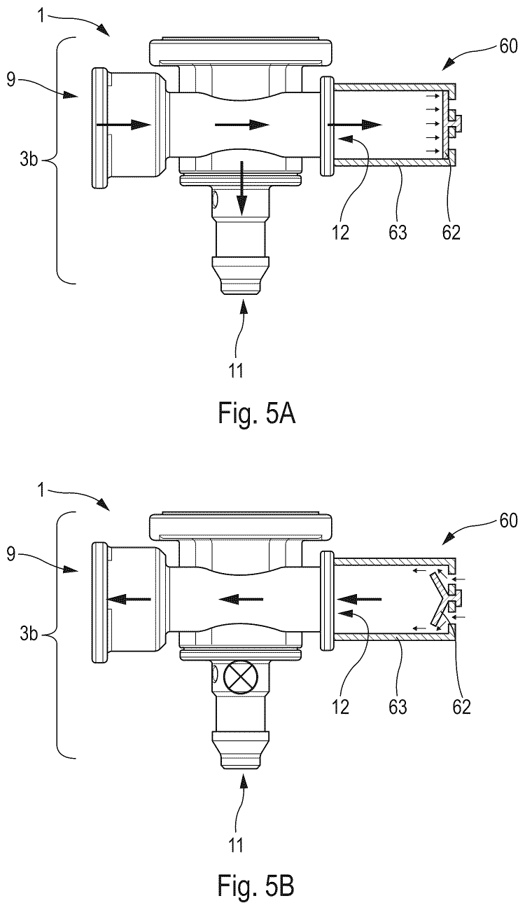

According to a second variant of this second embodiment, the element allowing air to enter the system 20 is a second nonreturn valve 60, which is arranged on one of the orifices of the valve and configured to prevent the passage of fluid when the motor of the pump 24 is operating in the first direction of rotation and to allow air to pass when the motor of the pump 24 is operating in the second direction of rotation. The valve 1 therefore comprises a third orifice 12 connected to a gas source, for example the outside ambient air, said nonreturn valve 60 being arranged on said third orifice. The second nonreturn valve 60 may comprise a deformable cylinder 61 arranged around a gas inlet formed by the body 63 of the valve 60. Thus, when the motor of the pump 24 is operating in the first direction of rotation, cleaning liquid rushes into the valve 60 and exerts pressure against the deformable cylinder 61, thereby preventing the passage of air via the inlet of said valve 60 (FIG. 4A). Conversely, when the motor of the pump 24 is operating in the second direction of rotation, a negative pressure is created within the system 20, which has the effect, on the one hand, of evacuating the cleaning liquid present within the second nonreturn valve 60 and, on the other hand, of causing the cylinder 61 to deform. Consequently, ambient air enters the system 20, thus creating a pressure equilibrium between the internal pressure of the system 20 and the outside ambient pressure, which allows the operation of purging the valve body 3 to be carried out without damaging the components of the system 20 (FIG. 4B). Alternatively, the second nonreturn valve 60 may comprise a deformable diaphragm 62 in abutment against the gas inlet formed by the body 63 of the valve 60. Thus, when the motor of the pump 24 is operating in the first direction of rotation, cleaning liquid rushes into the valve 60 and exerts pressure against the deformable diaphragm 62, thereby preventing the passage of air via the inlet of said valve 60 (FIG. 5A). Conversely, when the motor of the pump 24 is operating in the second direction of rotation, a negative pressure is created within the system 20, which has the effect, on the one hand, of evacuating the cleaning liquid present within the second nonreturn valve 60 and, on the other hand, of causing the diaphragm 62 to deform. Consequently, ambient air enters the system 20, creating a pressure equilibrium between the internal pressure of the system 20 and the outside ambient pressure, which allows the operation of purging the valve body 3 to be carried out without damaging the components of the system 20 (FIG. 5B).

The invention is not limited to the embodiments presented, and further embodiments will be clearly apparent to a person skilled in the art. By way of example, the invention also covers an embodiment according to which the purging means comprise both a second valve 50 and a second nonreturn valve 60, the latter being positioned on the orifice of the second valve 50 connected to the outside ambient air.

### LIST OF REFERENCE SIGNS

1: valve/first valve
3: valve body
3a: first part of the valve body
3b: second part of the valve body
5: hydraulic cavity
5a: first part of the hydraulic cavity
5b: second part of the hydraulic cavity
7: plunger
9: first orifice of the valve
11: second orifice of the valve
12: third orifice of the valve
13: coil
15: hydraulic channel
17: elastic stressing element/helical spring
20: system for spraying cleaning liquid
22: cleaning liquid reservoir
24: pump
26: spray endpiece
28: supply hose
30: distribution hose
50: second valve
51: second orifice of the second valve
60: second nonreturn valve
61: deformable cylinder
62: deformable diaphragm
63: body of the second nonreturn valve

What is claimed is:

1. A system for spraying a cleaning liquid, comprising:
a cleaning liquid reservoir,
a pump,
at least one spray endpiece for spraying cleaning liquid,
a nonreturn valve configured to prevent any fluid from entering the system from the spray endpiece for spraying liquid and
at least one valve including a valve body intended to receive the cleaning liquid and to selectively the cleaning liquid between the pump and the at least one spray endpiece,
a means for purging the valve body, the purging means being configured to allow gas to enter the system.

2. The system as claimed in claim 1, wherein the valve is a first valve, the purging means includes a second valve including a first orifice fluidically connected to an orifice of the first valve and a second orifice allowing the gas to enter the second valve.

3. The system as claimed in claim 2, wherein the second orifice of the second valve is fluidically connected to the outside ambient air.

4. The system as claimed in claim 2, wherein the first valve and the second valve are arranged so as to allow the cleaning liquid to return to the pump and to the liquid reservoir under the effect of gravity.

5. The system as claimed in claim 1, wherein the pump includes a reversible motor, the pump being configured to supply cleaning liquid to the valve body, in a first direction of rotation of the motor, and to draw the cleaning liquid from the valve body, in a second direction of rotation of the motor.

6. The system as claimed in claim 5, wherein the valve is a valve including three orifices, the system further comprising a second nonreturn valve arranged on one of the orifices, the second nonreturn valve being configured to prevent the passage of fluid when the motor of the pump is operating in the first direction of rotation and to allow air to pass when the motor of the pump is operating in the second direction of rotation.

7. The system as claimed in claim 6, wherein the second nonreturn valve includes a deformable diaphragm, the diaphragm being configured to deform under the action of a negative pressure generated by the pump when the motor of the pump is operating in the second direction of rotation.

8. The system as claimed in claim 6, wherein the second nonreturn valve includes a deformable cylinder, the cylinder being configured to deform under the action of a negative pressure generated by the pump when the motor of the pump is operating in the second direction of rotation.

9. The system as claimed in claim 1, wherein the valve is an electromagnetic valve with a coil configured to cause a plunger to move from a closed position to an open position and vice versa.
